(19) United States
(12) Patent Application Publication
(10) Pub. No.: US 2006/0294124 A1
(43) Pub. Date: Dec. 28, 2006

(54) Unbiased page ranking

(76) Inventor: Junghoo Cho, Los Angeles, CA (US)

Correspondence Address: Robert Berliner;BERLINER & ASSOCIATES, 31st Floor, 555 W. Fifth Street, Los Angeles, CA, 90013, US

(21) Appl. No.: 11/033,691

(22) Filed: Jan. 12, 2005

Related U.S. Application Data
(60) Provisional application No. 60/536,279, filed on Jan. 12, 2004.

(51) Int. Cl. G06F 7/00

(52) U.S. Cl. 707/101

(57) ABSTRACT

The pages in a network of linked pages are ranked based on the quality of the pages. Page quality is obtained by determining the change over time of the link structure of the page, which is obtained by determining the link structure of the page at different periods of time by taking multiple snapshots of the link structure of the network. The link structures are approximated by their PageRanks, page quality being determined by the formula:

$$Q ( p ) \approx D \cdot \frac{Δ PR ( p )}{PR ( p )} + PR ( p )$$

where Q(p) is the quality of the page, PR(p) is the current PageRank of the page, ΔPR(p) is the change over time in the PageRank of the page, and D is a constant that determines the relative weight of the terms ΔPR(p)/PR(p) and PR(p).

### CROSS-REFERENCE TO RELATED APPLICATIONS

This application claims the benefit of U.S. Provisional Application Ser. No. 60/536,279 filed Jan. 12, 2004, entitled “Page Quality: In Search for Unbiased Page Ranking,” by Junghoo Cho.

### BACKGROUND

1. Field of the Invention

This invention relates generally to computerized information retrieval, and more particularly to identifying related pages in a hyperlinked database environment such as the World Wide Web.

2. Related Art

Since its foundation in 1998, Google has become the dominant search engine on the Web. According to a recent estimate [15], about 75% of Web searches are being handled by Google directly and indirectly. For example, in addition to the keyword queries that Google gets directly from its sites, all keyword searches on Yahoo are routed to Google. Due to its dominance in the Web-search space, it is even claimed that “if your page is not indexed by Google, your page does not exist on the Web” [14]. While this statement may be an exaggeration, it contains an alarming bit of truth. To find a page on the Web, many Web users go to Google (or their favorite search engine which may be eventually routed to Google), issue keyword queries, and look at the results. If the users cannot find relevant pages after several iterations of keyword queries, they are likely to give up and stop looking for further pages on the Web. Therefore, a page that is not indexed by Google is unlikely to be viewed by many Web users.

The dominance of Google and the bias it may introduce influences people's perception of the Web. As Google is one of the primary ways that people discover and visit Web pages, the ranking of a page in Google's index has a strong impact on how pages are viewed by Web users. A page ranked at the bottom of a search result is unlikely to be viewed by many users.

While Google takes more than 100 factors into account in determining the final ranking of a page [8], the core of its ranking algorithm is based on a metric called PageRank [16, 4]. A more precise description of the PageRank metric will be given later, but it is essentially a “link-popularity” metric, where a page is considered important or “popular” if the page is linked to by many other pages on the Web. Roughly speaking, Google puts a page at the top in a search result (out of all the pages that contain the keywords that the user issued) when the page is linked to by the most other pages on the Web. PageRank and its variations are currently being used by major search engines [21]. The effectiveness of Google's search results and the adoption of PageRank by major search engines [21] strongly indicate that PageRank is an effective ranking metric for Web searches. The pages that are identified to be “highly important” by PageRank seem to be “high-quality” pages worth looking at.

While effective; one important problem is that PageRank is based on the current popularity of a page. Since currently-popular pages are repeatedly returned by search engines as the top results, they are “discovered” and looked at by more Web users, increasing their popularity even further. In contrast, a currently-unpopular page is often not returned by search engines, so few new links will be created to the page, pushing the page's ranking even further down. This “rich-get-richer” phenomenon can be particularly problematic for “high-quality” yet “currently-unpopular” pages. Even if a page is of high quality, the page may be completely ignored by Web users simply because its current popularity is very low. It is clearly unfortunate (both for the author of the new page and the overall Web users) that important and useful information is being ignored simply because it is new and has not had a chance to be noticed. A method is needed to rank pages based on their quality, not on their popularity. Thus, at the core of this problem lies the question of page quality, but what is meant by the quality of a page? Without a good definition of page quality, it is difficult to measure how much bias PageRank induces in its ranking and how well other ranking algorithms capture the quality of pages.

Book [20] provides a good overview of the work done in the Information Retrieval (IR) community that studies the problem of identifying the best matching documents to a user query. This body of work analyzes the content of the documents to find the best matches. The Boolean model, the vector-space model [19] and the probabilistic model [18, 6] are some of the well known models developed in this context. Some of these models (particularly the vector-space model) were adopted by many of the early Web search engines.

Researchers also investigated using the link structure of the Web to improve search results and proposed various ranking metrics. Hub and Authority [12] and PageRank [16] are the most well known metrics that use the Web link structure. Various ways have been described to improve PageRank computation [11, 10, 1]. Personalization of the PageRank metric by giving different weights to pages has been studied [9] A modification of the PageRank equation has been proposed to tailor it for Web administrators [22]. It has been proposed to rank Web pages by the user traffic to the pages to provide a traffic-prediction model based on entropy maximization [21]. In the database community, researchers also developed ways to rank database objects by modeling the object relationship as a graph [7] and measuring the object proximity.

There exists a large body of work that investigates the properties of the Web link structure [5, 2, 3, 17]. For example, it has been shown that the global link structure of the Web is similar to a “bow tie” [5]. It has also been shown that the number of in-bound or out-bound links follow a power-law distribution [5,2]. Other potential models on the Web link structure have been proposed [3, 17]. Other models developed in the IR community take a probabilistic approach [18, 6]. These models, however, measure the probability that a page belongs to the relevant set given a particular user query, not the general probability that a user will like a page when the user looks at the page.

### SUMMARY OF THE INVENTION

The present invention measures the general probability that a user will like a page when the user looks at the page. It clarifies the notion of page quality and introduces a formal definition of page quality. The quality metric of this invention is based on the idea that if the quality of a page is high, when a Web user reads the page, the user will probably like the page (and create a link to it). In accordance with this invention, the quality of a page is defined as the probability that a Web user will like the page (and create a link to it) when he reads the page. The invention then provides a quality estimator, or a practical way of estimating the quality of a page. The quality estimator analyzes the changes in the Web link structure and uses this information to estimate page quality. That the estimator measures the quality of a page well is verified by experiments conducted on real-world Web data. The estimator is theoretically shown to measure the exact quality of pages based on a simple and reasonable Web model.

In particular, page quality is obtained by determining the change over time of the link structure of the page, which is obtained by determining the link structure of the page at different periods of time by taking multiple snapshots of the link structure of the network. The link structures are approximated by their PageRanks, page quality being determined by the formula:

$$Q ( p ) \approx D \cdot \frac{Δ PR ( p )}{PR ( p )} + PR ( p )$$

where Q(p) is the quality of the page, PR(p) is the current PageRank of the page, ΔPR(p) is the change over time in the PageRank of the page, and D is a constant that determines the relative weight of the terms ΔPR(p)/PR(p) and PR(p).

### BRIEF DESCRIPTION OF DRAWINGS

FIG. 1 is a graph showing the time evolution of page popularity;

FIG. 2 is a graph showing the time evolution of I(p,t) and P(p,t) as predicted by the model of this invention;

FIG. 3 is a graph showing the time evolution of I(p,t) and P(p,t) as estimated based on the graph of FIG. 2;

FIG. 4 is the timeline for four experimental snapshots of Web sites used in an experiment to verify the model of this invention;

FIG. 5 is a graph showing the correlation of a quality estimator of this invention computed from three snapshots of the Web sites referred to in FIG. 4 and the PageRank value of the fourth snapshot of FIG. 4; and

FIG. 6 is a graph showing the correlation of the PageRank values of the third and fourth snapshots of FIG. 4.

### DETAILED DESCRIPTION OF THE INVENTION

As an initial matter, the word “we” is used in the “royal we” sense for ease of description and/or explanation, and should not be taken to signify or imply anything other than sole inventorship. In accordance with this invention:
We introduce a formal definition of page quality, which captures the intuitive concept of “page quality,” which we believe is the first formal definition of the quality of a page, and evaluate various ranking functions under the formal definition.
We show that Google's PageRank measures the formal definition of page quality very well under certain conditions. However, Google's PageRank is heavily biased against unpopular pages, especially the ones that were created recently.
We provide a direct and practical way of measuring page quality. This quality estimator avoids the bias inherent in popularity-based metrics, such as PageRank.
We propose a theoretical model on how users visit Web pages and how the popularity of a page evolves over time. Based on this theoretical model, we prove that the quality estimator of this invention can accurately measure the page quality.
We experimentally verify the effectiveness of the quality estimator based on real-world Web data. This experiment shows that the quality estimator can reduce the bias introduced by the PageRank metric. For example, in one experiment, the quality estimator “predicted” the future PageRank twice as accurately as predicted by the current PageRank.

Table 1 summarizes the notation we will be using:

TABLE 1
Symbols used throughout the specification

| Symbol | Meaning |
|---|---|
| PR(p) | PageRank of page p (Section on PageRank and popularity) |
| Q(p) | Quality of p (Definition 1) |
| P(p, t) | (Simple) popularity of p at t (Definition 2) |
| V(p, t) | Visit popularity of p at t (Definition 3) |
| A(p, t) | User awareness of p at t (Lemma 1) |
| I(p, t) | $Popularity increase function \text{:} I ( p , t ) = \frac{( n )}{( r )} \frac{\frac{ⅆ P ( p , t )}{ⅆ t}}{P ( p , t )}$ |
| a₀(p) | Initial user awareness of p at t = 0: a₀(p) = A(p, 0) |
| r | Visitation rate constant: V(p, t) = rP(p, t) |
| n | Total number of Web users |

PageRank and Popularity

It is useful to have a brief overview of the PageRank metric and explain how it is related to the notion of the “popularity” of a page. Intuitively, PageRank is based on the idea that a link from page p₁ to p₂ may indicate that the author of p₁ is interested in page p₂. Thus, if a page has many links from other pages, we may conclude that many people are interested in the page and that the page should be considered “important” or “of high quality.” Furthermore, we expect that a link from an important page (say, the Yahoo home page) carries more significance than a link from a random Web page (say, some individual's home page). Many of the “important” or “popular” pages go through a more rigorous editing process than a random page, so it would make sense to value the link from an important page more highly.

The PageRank metric PR(p), thus, recursively defines the importance of page p to be the weighted sum of the importance of the pages that have links to p. More formally, if a page has no outgoing link c, we assume that it has outgoing links to every single Web page. Next, consider page pⱼ that is pointed at by pages p₁, . . . , pₘ. Let cᵢ be the number of links going out of page pᵢ. Also, let d be a damping factor (whose intuition is given below). Then, the weighted link count to page pⱼ is given by
PR(pⱼ)=(1−d)+d[PR(p₁)/c₁+ . . . +PR(pₘ)/cₘ]
This leads to one equation per Web page, with an equal number of unknowns. The equations can be solved for the PR values. They can be solved iteratively, starting with all PR values equal to 1. At each step, the new PR(pᵢ) values are computed from the old PR(pᵢ) values (using the equation above), until the values converge. This calculation corresponds to computing the principal eigenvector of the link matrix [16].

One intuitive model for PageRank is that we can think of a user “surfing” the Web, starting from any page, and randomly selecting from that page a link to follow. When the user reaches a page with no outlines, he jumps to a random page. Also, when the user is on a page, there is some probability, d, that the next visited page will be completely random. This damping factor d makes sense because users will only continue clicking on links for a finite amount of time before they get distracted and start exploring something completely unrelated. With the remaining probability 1−d, the user will click on one of the c₁ links on page pᵢ at random. The PR(pⱼ) values we computed above give us the probability that the random surfer is at pⱼ at any given time.

Given the definition, we can interpret the PageRank of a page as its popularity on the Web. High PageRank implies that 1) many pages on the Web are “interested” in the page and that 2) more users are likely to visit the page compared to low PageRank pages. Given the effectiveness of Google's search results and its adoption by many Web search engines [21], PageRank seems to capture the “importance” or the “quality” of Web pages well. According to a recent survey the majority of users are satisfied with the top-ranked results from Google and from major search engines [13].

Quality and PageRank

While quite effective, one significant flaw of PageRank is that it is inherently biased against unpopular pages. For example, consider a new page that has just been created. We assume that the page is of very high quality and anyone who looks at the page agrees that the page should be ranked highly by search engines. Even so, because the page is new, there exist only a few (or no) links to the page and thus search engines never return the page or give it very low rank. Because search engines do not return it, few people “discover” this page, so the popularity of the page does not increase. The new high-quality page may never obtain a high ranking and get completely ignored by most Web users. To avoid this problem, the present invention provides a way to measure the “quality” of a page and promote high-quality (yet low popularity) pages.

Page quality can be a very subjective notion; different people may have completely different quality judgment on the same page. One person may regard a page very highly while another person may consider the page completely useless. Notwithstanding this subjectivity, the present invention provides a reasonable definition of page quality. Specifically, in accordance with the present invention, the quality of a page is quantified as the conditional probability that a random Web user will like the page (and create a link to it) once the user discovers and reads the page.

Definition 1 (page quality): Thus, we define the quality of a page p, Q(p), as the conditional probability that an average user will like the page p (and create a link to it) once the user discovers the page and gets aware of it. Mathematically,
Q(p)=P(Lₚ|Aₚ)
where Aₚ represents the event that the user gets aware of the page p and Lₚ represents that the user likes the page (and creates a link to p).

Given this definition, we can hypothetically measure the quality of page p by showing p to all Web users and getting the users' feedback on whether they like p or not (or by counting how many people create a link to p). For example, assuming the total number of Web users is 100, if 90 Web users like page p after they read it, its quality Q(p) is 0.9. We believe that this is a reasonable way of defining page quality given the subjectivity of page quality. When individual users have different opinions on the quality of a page, it is reasonable to consider a page of higher quality if more people are likely to “vote for” the page.

Under this definition, we note that it is possible that page p₁ is considered of higher quality than p₂ simply because p₁ discusses a more popular topic. For example, if pₛ is about the movie “Star Wars” and pₗ is about the movie “Latino” (a 1985 movie produced by George Lucas), pₛ may be considered of higher quality simply because more people know about the movie “Star Wars,” not necessarily because the page itself is of higher quality. That is, even though the content of pₗ is considered of higher quality than that of pₛ by the people who know both movies well, more people may like pg simply because they like the movie “Star Wars.” We expect that this bias induced from the topic of a page does not affect the effectiveness of a search engine. In most search scenarios, users have a particular topic in mind, and the search engine ranks pages only within the pages that are relevant to that topic. For example, if the user query is “Latino by George Lucas,” the search engine first identifies the pages relevant to the movie (by examining the keywords in the pages) and ranks pages only within those pages. Thus, the fact that “Latino” pages are considered of lower quality than “Star Wars” pages under the metric does not affect the effectiveness of the search engine.

The current popularity (PageRank) of a page estimates the quality of a page well if all Web pages have been given the same chance to be discovered by Web users; when pages have been looked at by the same set of people, the number of people who like the page (and create a link to it) is proportional to its quality. However, new pages have not been given the same chance as old and established pages, so the current popularity of new pages are definitely lower than their quality.

The Quality Estimator

The invention measures the quality of a page without asking for user feedback by using the evolution of the Web link structure. In this section, we intuitively derive the quality estimator and explain why it works. A more rigorous derivation and analysis of the quality estimator is provided later, below.

The main idea for quality measurement is as follows: The quality of a page is how many users will like a page (and create a link to it) when they discover the page. Therefore, instead of using the current number of links (or the PageRank) to measure the quality of a page, we use the increase in the number of links (or in the PageRank) to measure quality. This choice is based on the following intuition: if two pages are discovered by the same number of people during the same period, more people will create a link to the higher-quality page. In particular, the increase in the number of links (or in PageRank) is directly proportional to the quality of a page. Therefore, by measuring the increase in popularity, not the current popularity, we may estimate the page quality more accurately.

There exist two problems with this approach. The first problem is that pages are not visited by the same number of people. A popular page will be visited by more people than an unpopular page. Even if the quality of pages p₁ and p₂ are the same, if page p₁ is visited by twice as many people as p₂, it will get twice as many new links as p₂. To accommodate this fact, we need to divide the popularity increase by the number of visitors to this page. Given that PageRank (current popularity) captures the probability that a random Web surfer arrives at a page, we may assume that the number of visitors to a page is proportional to its current PageRank. We thus divide the increase in the number of links (or PageRank) by the current PageRank to measure quality.

The second problem is that the number of links (or the PageRank) of a well-known page may not increase too much because it is already known to most Web users. Even though many users visit the page, they do not create any more links to the page because they already know about it and have created links to it. Therefore, if we estimate the quality of a well-known page simply based on the increase in the number of links (or PageRank), the estimate may be lower than its true quality value. We avoid this problem by considering both the current PageRank of the page and the increase in the number of links (or PageRank). More precisely, we propose to measure the quality of page through the following formula:

$$Q ( p ) \approx D \cdot \frac{Δ PR ( p )}{PR ( p )} + PR ( p ) \qquad ( 1 )$$

Here, the first term

$$\frac{Δ PR ( p )}{PR ( p )}$$

estimates the quality of a page by measuring the increase in its PageRank. We may replace ΔPR(p) in the formula with the increase in the number of links. The second term PR(p) is to account for the well-known pages whose PageRank do not increase any more. When the PageRank (or the popularity) of a page has saturated, we believe that the saturated PageRank value reflects the quality of the page: higher-quality page is eventually linked to by more pages. The constant D in the formula decides the relative weight that we give to the increase in PageRank and to the current PageRank.

We can measure the values in the above formula in practice by taking multiple snapshots of the Web. That is, we download the Web multiple times, say twice, at different times. We then compute the PageRank of every page in each snapshot and take the PageRank difference between the snapshots. Using this difference and the current PageRank of a page, we can compute its quality value.

We will theoretically justify the above formula for quality estimation and derive it more formally later, below. Before this derivation, we first introduce a user-visitation model.

User-Visitation Model and Popularity Evolution

In the previous section, we explained the basic idea of how we measure the quality of a page using the increase of PageRank (or popularity). In the subsequent two sections, we more rigorously derive the popularity-increase-based quality estimator based on a reasonable user-visitation model. However, the proofs in the next two sections are not necessary to understand the core idea of this invention.

For the formalization, we first introduce two notions of popularity: (simple) popularity and visit popularity.

Definition 2 (Popularity): We define the popularity of page p at time t, P(p, t), as the fraction of Web users who like the page. Under this definition, if 100,000 users (out of, say, one million) currently like page pₗ, its popularity is 0.1. We emphasize the subtle dif^{f}erence between the quality of a page and the popularity of a page. The quality is the probability that a Web user will like the page if the user discovers the page, while the popularity is the current fraction of Web users who like the page. Thus, a high-quality page may have low popularity because few users are currently aware of the page.

We note that the exact popularity of a page is difficult to measure in practice. However, we may use the PageRank of a page (or the number of links to the page) as a surrogate to its popularity.

The second notion of popularity, visit popularity, measures how many “visits” a page gets.

Definition 3 (Visit Popularity): We define the visit popularity of a page p at time t, V(p, t), as the number of “visits” or “page views” a page gets within a unit time interval at time t. There is a similarity of the visit popularity to PageRank. According to the random Web-surfer model, the PageRank of p represents the probability that a random Web surfer arrives at the page, so the number of visits to p (or visit popularity) is roughly equivalent to the PageRank of p.

There are two basic hypotheses of the user-visitation model. The first hypothesis is that a page is visited more often if the page is more popular.

Proposition 1 (Popularity-Equivalence Hypothesis): The number of visits to page p within a unit time interval at time t is proportional to how many people like the page. That is,
V(p, t)=rP(p, t)
where r is the visitation-rate constant, which is the same for all pages. We believe the popularity-equivalence hypothesis is a reasonable assumption. If many people like a page, the page is likely to be visited by many people.

The second hypothesis is that a visit to page p can be done by any Web user with equal probability. That is, if there exist n Web users and if a page p was just visited by a user, the visit may have been done by any Web user with 1/n probability.

Proposition 2 (Random-Visit Hypothesis): Any visit to a page can be done by any Web user with equal probability.

Using these two hypotheses, we now study how the popularity of a page evolves over time. For this study, we first prove the following lemma.

Lemma 1: The popularity of p at time t, P(p, t), is equal to the fraction of Web users who are aware of p at t, A(p, t), times the quality of p.
P(p,t)=A(p,t)·Q(p)
Proof: In order for a Web user to like the page p, the user has to be aware of p and like the page. The probability that a random Web user is aware of the page is A(p, t). The probability that the user will like the page is Q(p) (Definition 1). Thus, P(p,t)=A(p,t)·Q(p).
   We refer to A(p, t) as the user-awareness function of p. Note that P(p, t) and A(p, t) are functions of time t, but Q(p) is not. In the model, we assume that the quality Q(p) is an inherent property of p that does not change over time. Therefore, the popularity of page p, P(p, t), changes over time not because its quality changes, but because users' awareness of the page changes.

Based on the above lemma, we first compute how users' awareness, A(p, t), evolves over time. For the derivation, we assume that there are n Web users in total.

Lemma 2: The user awareness function A(p, t) evolves over time through the following formula:
A(p,t)=1−e^{-r/n∫}^{₀}^{^{t}}^{P(p,t)dt}
Proof: V(p, t) is the rate at which Web users visit the page p at t Thus bytime t, page p is visited ∫₀^{t}V(p,t)dt=r∫₀^{t}P(p,t)dt times.

Without losing generality, we compute the probability that user u₁ is not aware of the page p when the page has been visited k times. The probability that the ith visit to p was not done by u₁ is (1−1/n). Therefore, when p has been visited k times, u₁ would have never visited p (thus, would not be aware of p) with probability (1−1/n)^{k}. By time t, the page is visited ∫₀^{t}V(p,t)dt times. Then the probability that the user is not aware of p at time t, 1−A(p,t) is

$$\begin{matrix}1 - 𝒜 ( p , t ) = {( 1 - \frac{1}{n} )}^{{\int }_{0}^{t} 𝒱 ( p , t ) ⅆ t} \\ = {( 1 - \frac{1}{n} )}^{r {\int }_{0}^{t} 𝒫 ( p , t ) ⅆ t} \\ = {[ {( 1 - \frac{1}{n} )}^{- n} ]}^{- \frac{r}{n} {\int }_{0}^{t} 𝒫 ( p , t ) ⅆ t}\end{matrix}$$

$$When n -> ∞ , {( 1 - \frac{1}{n} )}^{- n} -> ⅇ . Thus , 1 - 𝒜 ( p , t ) = {ⅇ}^{- \frac{r}{n} {\int }_{0}^{t} 𝒫 ( p , t ) ⅆ t}$$

By combining the results of Lemmas 1 and 2, we can derive the time evolution of popularity.

Theorem 1: The popularity of page p evolves over time through the following formula

$$𝒫 ( p , t ) = \frac{{a}_{0} ( p ) Q ( p )}{{a}_{0} ( p ) + [ 1 - {a}_{0} ( p ) ] {ⅇ}^{- [ \frac{r}{n} Q ( p ) ] t}}$$

Here, aₒ(p) is the user awareness of the page p at time zero when the page was first created.

Proof: From Lemmas 1 and 2,
P(p,t)=[1−e^{-r/n∫}^{₀}^{^{t}}^{P(p,t)dt}]Q(p)
If we substitute e^{-r/n∫}^{₀}^{^{t}}^{P(p,t)dt} with f (t), P(p,t) is equivalent to

$$( - \frac{n}{r} ) ( \frac{ⅆ f}{ⅆ t} / f ) .$$

Thus,

$$( - \frac{n}{ r} ) ( \frac{1}{ f} ) \frac{ⅆ f}{ⅆ t} = ( 1 - f ) Q ( p ) \qquad ( 2 )$$

Equation 2 is known as Verhulst equation (or logistic growth equation) which often arises in the context of population growth [23]. The solution to the equation is

$$f ( t ) = \frac{1}{1 + C {ⅇ}^{\frac{r}{n} Q ( p ) t}}$$

where C is a constant to be determined by the boundary condition. Since f(t)=e^{-r/n∫}^{₀}^{^{t}}^{P(p,t)dt},

$${ⅇ}^{- \frac{r}{n} {\int }_{0}^{t} 𝒫 ( p , t ) ⅆ t} = \frac{1}{C {ⅇ}^{\frac{r}{n} Q ( p ) t}} \qquad ( 3 )$$

If we take the logarithm of both sides of Equation 3 and differentiate by t,

$$( - \frac{r}{n} ) P ( p , t ) = \frac{\frac{r}{n} Q ( p ) C {ⅇ}^{\frac{r}{n} Q ( p ) t}}{1 + C {ⅇ}^{\frac{r}{n} Q ( p ) t}}$$

After rearrangement, we get

$$P ( p , t ) = \frac{CQ ( p )}{C + {ⅇ}^{- \frac{r}{n} Q ( p ) t}} \qquad ( 4 )$$

We now determine the constant C. From Lemma 1
P(p,0)=A(p,0)·Q(p) (5)
when t=O. From Equation 4

$$P ( p , 0 ) = \frac{CQ ( p )}{C + 1} \qquad ( 6 )$$

From Equations 5 and 6,

$$C = \frac{A ( p , 0 )}{1 - A ( p , 0 )} \qquad ( 7 )$$

Setting a₀(p)=A(p,0), we finally get the following formula:

$$P ( p , t ) = \frac{{a}_{0} ( p ) Q ( p )}{{a}_{0} ( p ) + [ 1 - {a}_{0} ( p ) ] {ⅇ}^{- \frac{r}{n} Q ( p ) t}}$$

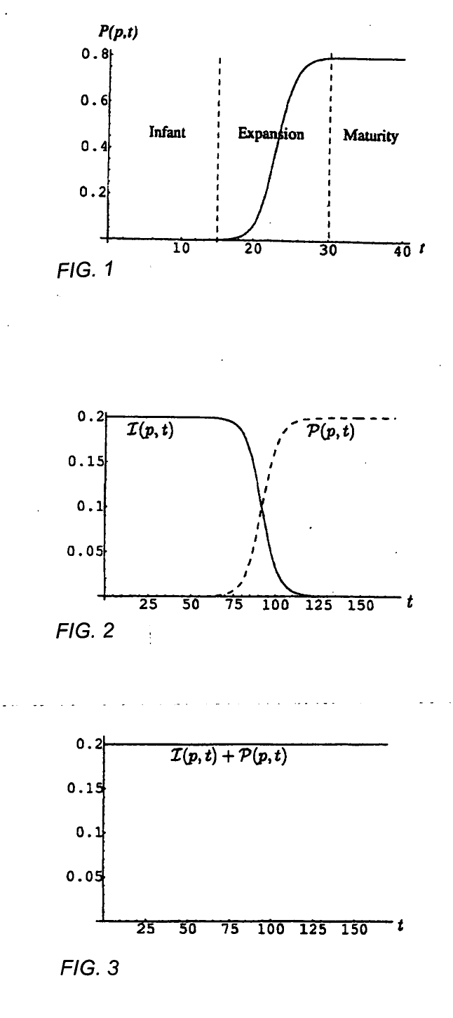

Note that the result of Theorem 1 tells us exactly how the popularity of a page evolves over time when its quality is Q(p) and its initial awareness is aₒ(p). FIG. 1 shows an example of this time evolution. We assumed Q(p)=0.8, n=10⁸, r=10⁸ and a₀=10⁻⁸. Roughly, these parameters correspond to the case where there are 100 million Web users and only one user is aware of the page p at its creation. The quality is relatively high at 0.8. The horizontal axis corresponds to the time. The vertical axis corresponds to the popularity P(p,t) at the given time.

From the graph, we can see that a page roughly goes through three stages after its birth: the infant stage, the expansion stage, and the maturity stage. In the first infant stage (between t=0 and t=15) the page is barely noticed by Web users and has practically zero popularity. At some point (t=15), however, the page enters the second expansion stage (t=15 and 30), where the popularity of the page suddenly increases. In the third maturity stage, the popularity of the page stabilizes at a certain value. Interestingly, the length of the first two stages are roughly equivalent. Both the infant and the expansion stages are about 15 time units when Q(p)=0.8. We could observe this equivalence of the lengths for most other parameter settings.

We also note that the eventual popularity of p is equal to its quality value 0.8. The following corollary shows that this equality holds in general.

Corollary 1: The popularity of page p, P(p,t), eventually converges to Q(p). That is, when t→∞ P(p,t)→Q(p).

Proof: From Theorem 1,

$$P ( p , t ) = \frac{{a}_{0} ( p ) Q ( p )}{{a}_{0} ( p ) + [ 1 - {a}_{0} ( p ) ] {ⅇ}^{- [ \frac{r}{n} Q ( p ) ] t}}$$

When t→∞, e^{-[r/nQ(p)]t}→0. Thus,

$$P ( p , t ) = \frac{{a}_{0} ( p ) Q ( p )}{{a}_{0} ( p ) + [ 1 - {a}_{0} ( p ) ] {ⅇ}^{- [ \frac{r}{n} Q ( p ) ] t}} \to \frac{{a}_{0} ( p ) Q ( p )}{{a}_{0} ( p )} = Q ( p )$$

The result of this corollary is reasonable. When all users are aware of the page, the fraction of all Web users who like the page is the quality of the page.
Theoretical Derivation of the Quality Estimator

Assuming the user-visitation model described in the previous section, we now study how we can measure the quality of a page. The main idea in the section on the quality estimator was that we can estimate the quality of a page by measuring the popularity-increase of the page. To verify this idea, we take the time derivative of P(p,t) in Theorem 1 and get the following corollary.

Corollary 2: The quality of a page is proportional to its popularity increase and inversely proportional to its current popularity. It is also inversely proportional to the fraction of the users who are unaware of the page, 1−A(p,t).

$$Q ( p ) = ( \frac{n}{r} ) \frac{ⅆ P ( p , t ) / ⅆ t}{P ( p , t ) ( 1 - A ( p , t ) )}$$

Proof: By differentiating the equation in Theorem 1, we get

$$\frac{ⅆ P}{ⅆ t} = \frac{ⅆ A}{ⅆ t} Q ( p ) \qquad ( 8 )$$

From Lemma 2,

$$\begin{matrix}\frac{ⅆ A}{ⅆ t} = - \frac{ⅆ}{ⅆ t} {ⅇ}^{- \frac{r}{n} {\int }_{0}^{t} P ( p , t ) ⅆ t} \\ = - ( {ⅇ}^{- \frac{r}{n} {\int }_{0}^{t} P ( p , t ) ⅆ t} ) ( - \frac{r}{n} P ( p , t ) ) \\ = ( 1 - A ( p , t ) ) ( \frac{r}{n} P ( p , t ) )\end{matrix} \qquad ( 9 )$$

From Equations 8 and 9, we get

$$Q ( p ) = ( \frac{n}{r} ) \frac{ⅆ 𝒫 ( p , t ) / ⅆ t}{𝒫 ( p , t ) ( 1 - 𝒜 ( p , t ) )}$$

Note that the result of this corollary is very similar to the first term in Equation 1, ΔPR(p)/PR(p): The corollary shows that the quality of a page is proportional to the increase of its popularity over its current popularity. The only additional factor in the corollary is 1−A(p,t). Later we will see that this factor is essentially responsible for the second term of Equation 1. For now we ignore this additional factor and study the property of

$$( \frac{n}{r} ) \frac{ⅆ 𝒫 ( p , t ) / ⅆ t}{𝒫 ( p , t )}$$

as the quality estimator. We refer to

$$( \frac{n}{r} ) \frac{ⅆ 𝒫 ( p , t ) / ⅆ t}{𝒫 ( p , t )}$$

as the popularity-increase function, I(p,t).

In FIG. 2, we show the time evolution of I(p,t) when Q(p) is 0.2. The horizontal axis is the time and the vertical axis shows the value of the function. We obtained this graph analytically using the equation of Theorem 1. The remaining parameters are set to n=10⁸, r=10⁸ and a₀=10⁻⁸. The solid line in the graph shows the popularity-increase function I(p,t). We also show the time evolution of the popularity function P(p,t)as a dashed line in the figure for comparison purposes.

From the graph, we can see that the popularity-increase function I(p,t) measures the quality of the page Q(p) very well in the beginning when the page was just created (t<75). During this time, I(p,t) 0.2=Q(p). In contrast, the popularity P(p,t) works very poorly as the estimator of Q(p) during this time. The poor result of P(p,t) is expected because when few users are aware of the page, its popularity is much lower than its quality. As time goes on, however, the popularity-increase function I(p,t) loses its merit as the estimator of Q(p). I(p,t) gets much smaller than Q(p) as more users discover the page. This result is also reasonable, because when most users on the Web are aware of the page, the popularity of the page cannot increase any further, so the popularity-increase-based quality estimator will be much smaller than Q(p). Fortunately in this region, we can see that P(p,t) works well as the quality estimator: When most users on the Web are aware of the page, the fraction of Web users who like the page roughly corresponds to the quality of the page.

From the two graphs of I(p,t) and P(p,t), we can expect that we may estimate the quality of the page accurately if we add these two functions. In FIG. 3, we show the time evolution of this addition, I(p,t)+P(p,t), for the same parameters as in FIG. 2. We can see that I(p,t)+P(p,t) is a straight line at the quality value 0.2. Based on these observations, we now prove that I(p,t)+P(p,t)is always equal to the page quality Q(p).

Theorem 2: The quality of page p, Q(p),is always equal to the sum of its popularity increase I(p,t) and its popularity P(p,t).
Q(p)=I(p,t)+P(p,t)
Proof: From Theorem 1,

$$𝒫 ( p , t ) = \frac{{a}_{0} ( p ) Q ( p )}{{a}_{0} ( p ) + [ 1 - {a}_{0} ( p ) ] {ⅇ}^{- [ \frac{r}{n} Q ( p ) ] t}}$$

From this equation, we can compute the analytical form of: I(p,t):

$$\begin{matrix}ℐ ( p , t ) = ( \frac{n}{r} ) \frac{ⅆ 𝒫 ( p , t ) / ⅆ t}{𝒫 ( p , t )} \\ = \frac{[ 1 - {a}_{0} ( p ) ] Q ( p ) {ⅇ}^{- \frac{r}{n} Q ( p ) t}}{{a}_{0} ( p ) + [ 1 - {a}_{0} ( p ) ] {ⅇ}^{- \frac{r}{n} Q ( p ) t}}\end{matrix}$$

$$Thus , \\ \begin{matrix}ℐ ( p , t ) + 𝒫 ( p , t ) = \frac{[ 1 - {a}_{0} ( p ) ] Q ( p ) {ⅇ}^{- \frac{r}{n} Q ( p ) t}}{{a}_{0} ( p ) + [ 1 - {a}_{0} ( p ) ] {ⅇ}^{- \frac{r}{n} Q ( p ) t}} + \\ \frac{{a}_{0} ( p ) Q ( p )}{{a}_{0} ( p ) + [ 1 - {a}_{0} ( p ) ] {ⅇ}^{- \frac{r}{n} Q ( p ) t}} \\ = \frac{Q ( p ) \{ [ 1 - {a}_{0} ( p ) ] {ⅇ}^{- \frac{r}{n} Q ( p ) t} + {a}_{0} ( p ) \}}{{a}_{0} ( p ) + [ 1 - {a}_{0} ( p ) ] {ⅇ}^{- \frac{r}{n} Q ( p ) t}} \\ = Q ( p )\end{matrix}$$

Based on the result of Theorem 2, we define I(p,t)+P(p,t) as the quality estimator of p, Q(p,t):

$$Q ( p , t ) = ℐ ( p , t ) + 𝒫 ( p , t ) = ( \frac{n}{r} ) ( \frac{ⅆ 𝒫 ( p , t ) / ⅆ t}{𝒫 ( p , t )} ) + 𝒫 ( p , t ) \qquad ( 10 )$$

Notice the similarity of Equations 1 and 10. The quality estimator that we derived from the user-visitation model is practically identical to the estimator that we derived intuitively: The quality of a; page is equal to the sum of popularity increase and its current popularity.

Also note that if we use the PageRank, PR(p), as the popularity measure of page p, P(p,t), we can measure all terms in Equation 10: After downloading Web pages, we compute PR(p) for every p and use it for P(p,t). To measure the popularity increase dP(p,t)/dt we download the Web again after a while, and measure the difference of the PageRanks between the downloads. The only unknown factor in Equation 10 is n/r which is a constant common to all pages. We will need to determine this factor experimentally. In summary, under the user-visitation model, we proved that we can measure the quality of all pages by downloading the Web multiple times.

Experiments

Given that the ultimate goal is to find high-quality pages and rank them highly in search results, the best way to evaluate the new quality estimator is to implement it on a large-scale search engine and see how well users perceive the new ranking. This approach is clearly difficult when we cannot modify and control the internal ranking mechanisms of commercial search engines.

Because of this limitation, we take an alternative approach to evaluating the proposed quality estimator. The main idea is that the popularity or PageRank of a page is a reasonably good estimator of its quality if the page has existed on the Web for a long period. Thus, the future PageRank of a page will be closer to its true quality than its current PageRank. Therefore, if the quality estimator estimates the quality of pages well, the estimated page quality from today's Web should be closer to the future PageRank (say, one year from today) than the current PageRank. In other words, the quality estimator should be a better “predictor” of the future PageRank than the current PageRank.

Based on this idea, we capture multiple snapshots of the Web, compute page quality, and compare today's quality value with the PageRank values in the future. As we will explain in detail later, the result from this experiment demonstrates that the quality estimator shows significantly less “error” in predicting future PageRanks than current PageRanks. We first explain the experimental setup.

Experimental Setup

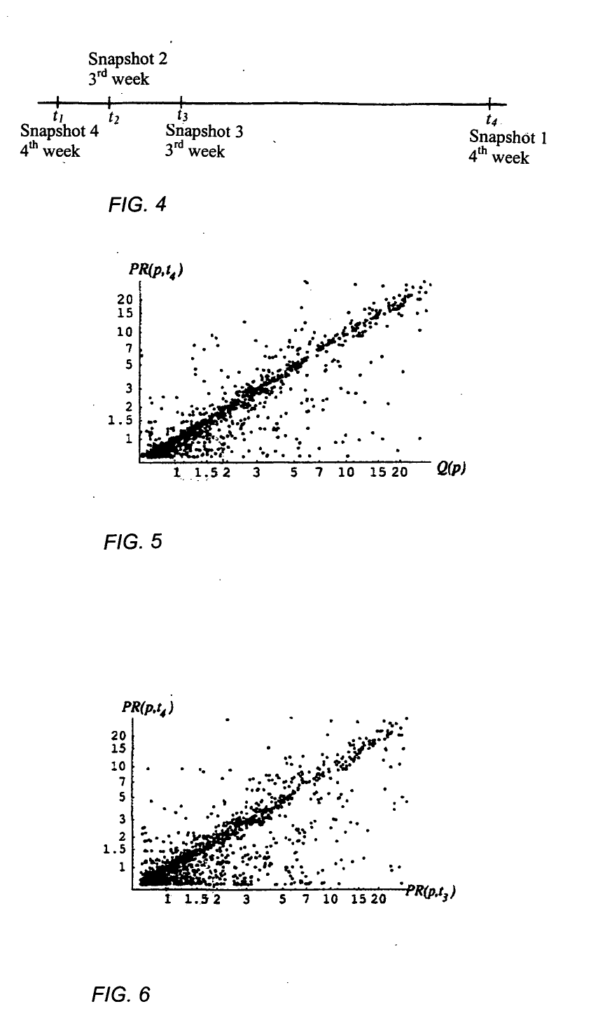

Due to limited network and storage resources, experiments were restricted the to a relatively small subset of the Web. In the experiment we downloaded pages on 154 Web sites (e.g., acm.org, hp.com, etc.) four times over the period of six months. The list of the Web sites were collected from the Open Directory (http://dmoz.org). The timeline of the snapshots is shown in FIG. 4. Roughly, the first three snapshots were taken with one-month interval between them and the last snapshot was taken four months after the third snapshot. We refer to the time of each snapshot as t₁, t₂, t₃ and t₄. The first three snapshots were used to compute the quality of pages and the last snapshot was used as the “future” PageRank.

The snapshots were quite complete mirrors of the 154 Web sites. We downloaded pages from each site until we could not reach any more pages from the site or we downloaded the maximum of 200,000 pages. Out of 154 Web sites, only four Web sites had more than 200,000 pages. The number of pages that we downloaded in each snapshot ranged between 4.6 million pages and 5 million pages. Since we were interested in comparing the estimated page quality with the future PageRank, we first identified the set of pages downloaded in all snapshots. Out of 5 million pages, 2.7 millions pages were common in all four snapshots. We then computed the PageRank values from the sub graph of the Web obtained from these 2.7 million pages for each snapshot. For the computation, we used 0.3 as the damping factor (see the section on PageRank and popularity) and used 1 as the initial PageRank value of each page. The final computed PageRank values ranged between 0.67 and 21000 in each snapshot. The minimum value 0.67 and the maximum value 21000 were roughly the same in all four snapshots.

Quality and Future PageRank

Using the collected data, we estimated the quality of a page based on the PageRank increase between t₁ and t₃. We then compared the estimated quality to the PageRank at t₄ and measured the difference. In estimating page quality, we first identified the set of pages whose PageRank values had consistently increased (or decreased) over the first three snapshots (i.e., the pages with PR(p, t₁)<PR(p, t₂)<PR(p, t₃)). For these pages, we computed the quality through the following formula:

$$Q ( p ) = 0.1 \cdot [ \frac{PR ( p , {t}_{3} ) - PR ( p , {t}_{1} )}{PR ( p , {t}_{1} )} ] + PR ( p , {t}_{3} )$$

That is, we computed the PageRank increase by taking the difference between t₁ and t₃ (ΔPR(p)=PR(p, t₃)−PR(p, t₁)) and dividing it by PR(p, t₁). We then added this number to PR(p, t₃) to estimate the page quality. As the constant factor D in Equation 1, we used the value 0.1, which showed the best result out of all values we tested. Small variations in the constant did not significantly affect the results.

In FIG. 5, we show the correlation of the quality estimate Q(p) computed from the first three snapshots and the PageRank value of the fourth snapshot, PR(p, t₄). The horizontal axis corresponds to Q(p) and the vertical axis corresponds to PR(p, t₄). For comparison purposes, we also show the correlation of the third PageRank value PR(p, t₃) and the fourth PageRank value PR(p, t₄) in FIG. 6. If the PageRank of a page did not change between t₁ and t₃, the estimated quality Q(p) is identical to P(p, t₃). Since the majority of pages did not show a significant change in PageRank values, we plotted the graphs only for the pages whose PageRank values changed more than 5% between t₁ and t₃. By limiting to these pages, we could make the difference between the two graphs easier to see.

While the graphs may look similar at the first glance, we can see that FIG. 5 shows stronger correlation than FIG. 6 if we examine the two graphs carefully. The dots in FIG. 5 are more clustered around the diagonal than in FIG. 6. For example, in the off-diagonal area marked by a circle in the graphs, we see that FIG. 6 contains more dots than FIG. 5. (The total number of dots in both graphs are the same.)

In order to quantify how well Q(p) (or PR(p, t₃)) predicts the future PageRank PR(p, t₄), we compute the average relative “error” between Q(p) and PR(p, t₄) (or between PR(p, t₃) and PR(p, t₄)). That is, we compute the relative error

$$err ( p ) = \vert \frac{PR ( p , {t}_{4} ) - Q ( p )}{PR ( {t}_{4} )} \vert for Figure 5$$

$$err ( p ) = \vert \frac{PR ( p , {t}_{4} ) - PR ( p , {t}_{3} )}{PR ( p , {t}_{4} )} \vert for Figure 6$$

for all dots in the graphs and compare their average errors.

From this comparison, we could observe that the average relative error is significantly smaller for Q(p) than PR(p, t₃). The average error was 0.32 for Q(p) while it was 0.79 for PR(p, t₃). That is, the estimated quality Q(p) predicted the future PageRank twice more accurately than PR(p, t₃) on average.

Conclusion

At a very high level, we may consider the quality estimator as a third-generation ranking metric. The first-generation ranking metric (before PageRank) judged the relevance and quality of a page mainly based on the content of a page without much consideration of Web link structure. Then researchers [12, 16J proposed a second-generation ranking metrics that exploited the link structure of the Web. The present invention further improves the ranking metrics by considering not just the current link structure, but also the evolution and change in the link structure. Since we are taking one more information into account when we judge page quality, it is reasonable to expect that the ranking metric performs better than existing ones.

As more digital information becomes available, and as the Web further matures, it will get increasingly difficult for new pages to be discovered by users and get the attention that they deserve. The ranking metric of this invention will help alleviate this “information imbalance” problem that only established pages are repeatedly looked at by users. By identifying “high-quality” pages early on and promoting them, the new metric can make it easier for new and high-quality pages get the attention that they may deserve.

Each of the following references are hereby incorporated by reference. In addition, U.S. Provisional Application Ser. No. 60/536,279 filed Jan. 12, 2004, entitled “Page Quality: In Search for Unbiased Page Ranking,” by Junghoo Cho, is hereby incorporated herein by reference.

### REFERENCES

[1] Serge Abiteboul, Mihai Freda, and Grgory Cobna. Adaptive on-line page importance computation. In Proceedings of the International World-Wide Web Conference, May 2003.
[2] Reka Albert, Albert-Laszlo Barabasi, and Hawoong Jeong. Diameter of the World Wide Web. Nature, 401(6749):130-131, September 1999.
[3] Albert-Laszlo Barabasi and Reka Albert. Emergence of scaling in random networks. Science, 286(5439):509-512, October 1999.
[4] Sergey Brin and Lawrence Page. The anatomy of a large-scale hypertextual web search engine. In Proceedings of the International World-Wide Web Conference, April 1998.
[5] Andrei Broder, Ravi Kumar, Farzin Maghoul, Prabhakar Raghavan, Sridhar Rajagopalan, Raymie Stata, Andrew Tomkins, and Janet Wiener. Graph structure in the web: experiments and models. In Proceedings of the International World-Wide Web Conference, May 2000.
[6] Norbert Fuhr. Probabilistic models in information retrieval. The Computer Journal, 35(3):243-255, 1992.
[7] Roy Goldman, Narayanan Shivakumar, Suresh Venkatasubramanian, and Hector Garcia-Molina. Proximity search in databases. In Proceedings of the International Conference on Very Large Databases (VLDB), pages 26-37, 1998.
[8] Google information for webmasters. Available at http://www.google.com/webmasters/.
[9] Taher H. Haveliwala. Topic-sensitive pagerank. In Proceedings of the International World-Wide Web Conference, May 2002.
[10] Sepandar Kamvar, Taher Haveliwala, and Gene Golub. Adaptive methods for the computation of pagerank. In Proceedings of International Conference on the Numerical Solution of Markov Chains, September 2003.
[11] Sepandar Kamvar, Taher Haveliwala, Christopher Manning, and Gene Golub. Extrapolation methods for accelerating pagerank computations. In Proceedings of the International World-Wide Web Conference, May 2003.
[12] Jon Kleinberg. Authoritative sources in a hyperlinked environment. Journal of the ACM, 46(5):604-632, September 1999.
[13] Npd search and portal site study. Available at http://www.npd.com/press/releases/press 000919.htm.
[14] Stefanie Olsen. Does search engine's power threaten web's independence? Available at http://news.com.com/2009-1023-963618.html, October 2002.
[15] Search engine market research by onestat.com. Brief summary is available at http://www. onestat.com/html/aboutus_pressbox21.html, May 2002.
[16] Lawrence Page, Sergey Brin, Rajeev Motwani, and Terry Winograd. The pagerank citation ranking: Bringing order to the web. Technical report, Stanford University Database Group, 1998. Available at http://dbpubs.stanford.edu:8090/pub/1999-66.
[17] David M. Pennock, Gary W. Flake, Steve Lawrence, Eric J. Glover, and C. Lee Giles. Winners don't take all: Characterizing the competition for links on the web. Proceedings of the National Academy of Sciences, 99(8):5207-5211, 2002.
[18] Stephen E. Robertson and Karen Sparck-Jones. Relevance weighting of search terms. Journal of the American Society for Information Science, 27(3):129-146, 1975.
[19] Gerard Salton. The SMART Retrieval System—Experiments in Automatic Document Processing. Prentice Hall Inc., 1971.
[20] Gerard Salton and Michael J. McGill. Introduction to modern information retrieval. McGraw-Hill, 1983.
[21] John A. Tomlin. A new paradigm for ranking pages on the world wide web. In Proceedings of the International World-Wide Web Conference, May 2003.
[22] Ah Chung Tsoi, Gianni Morini, Franco Scarselli, Markus Hagenbuchner, and Marco Maggini. Adaptive ranking of web pages. In Proceedings of the International World-Wide Web Conference, May 2003.
[23] Ferdinand Verhulst. Nonlinear Differential Equations and Dynamical Systems. Springer Verlag, 2nd edition, 1997.

1. In a method for determining a ranking of pages in a network of linked pages, some pages being linked to other pages, the improvement comprising:
determining the ranking based on the quality of the pages.

2. The improvement of claim 1 in which page quality is obtained by determining the change over time of the link structure of the page.

3. The improvement of claim 2 in which the change over time in the link structure of the page is obtained by determining the link structure of the page at a first period of time and determining the link structure of the page at a second period of time.

4. The improvement of claim 3 in which the change over time in the link structure of the page is divided by the link structure of the page at one of the periods of time.

5. The improvement of claim 3 in which the change over time in the link structure of the page is divided by the link structure of the page at the second period of time.

6. The improvement of claim 5, in which to the change over time in the link structure of the page divided by the link structure of the page at the second period of time, is added the link structure of the page at the second period of time.

7. The improvement of claim 6, in which either (a) the change over time in the link structure of the page divided by the link structure of the page at the second period of time, or (b) the link structure of the page at the second period of time, is multiplied by a constant that determines the relative weight of calculation (a) and (b).

8. The improvement of claim 2 in which the change over time in the link structure of the page is obtained by taking multiple snapshots of the link structure of the network.

9. The improvement of claim 3 in which the link structures of the page at said first and second periods of time is obtained by determining the PageRanks of the page at said first and second periods of time.

10. The improvement of claim 9 in which page quality is determined by the formula:
$$Q ( p ) \approx D \cdot \frac{Δ PR ( p )}{PR ( p )} + PR ( p )$$
where Q(p) is the quality of the page, PR(p) is the current PageRank of the page, ΔPR(p) is the change over time in the PageRank of the page, and D is a constant that determines the relative weight of the terms ΔPR(p)/PR(p) and PR(p).

11. A computer readable storage medium having stored thereon one or more computer programs for implementing a method of assigning relevancy ratings to a plurality of pages in a network of linked pages, some pages being linked to other pages, the one or more computer programs comprising instructions for detecting a user query of the network, and determining the ranking of pages in the network related to the user's query based on the quality of the pages.

12. The computer readable storage medium of claim 11 in which page quality is obtained by determining the change over time of the link structure of the page.

13. The computer readable storage medium of claim 12 in which the change over time in the link structure of the page is obtained by determining the link structure of the page at a first period of time and determining the link structure of the page at a second period of time.

14. The computer readable storage medium of claim 13 in which the change over time in the link structure of the page is divided by the link structure of the page at one of the periods of time.

15. The computer readable storage medium of claim 13 in which the change over time in the link structure of the page is divided by the link structure of the page at the second period of time.

16. The computer readable storage medium of claim 15, in which to the change over time in the link structure of the page divided by the link structure of the page at the second period of time, is added the link structure of the page at the second period of time.

17. The computer readable storage medium of claim 16, in which either (a) the change over time in the link structure of the page divided by the link structure of the page at the second period of time, or (b) the link structure of the page at the second period of time, is multiplied by a constant that determines the relative weight of calculation (a) and (b).

18. The computer readable storage medium of claim 12 in which the change over time in the link structure of the page is obtained by taking multiple snapshots of the link structure of the network.

19. The computer readable storage medium of claim 13 in which the link structures of the page at said first and second periods of time is obtained by determining the PageRanks of the page at said first and second periods of time.

20. The computer readable storage medium of claim 19 in which page quality is determined by the formula:
$$Q ( p ) \approx D \cdot \frac{Δ PR ( p )}{PR ( p )} + PR ( p )$$
where Q(p) is the quality of the page, PR(p) is the current PageRank of the page, ΔPR(p) is the change over time in the PageRank of the page, and D is a constant that determines the relative weight of the terms ΔPR(p)/PR(p) and PR(p).
